(19) United States
(12) Patent Application Publication
(10) Pub. No.: US 2023/0162389 A1
(43) Pub. Date: May 25, 2023

(54) IMAGE DISPLAY APPARATUS

(71) Applicant: TOYOTA JIDOSHA KABUSHIKI KAISHA, Aichi-ken (JP)

(72) Inventors: Hideki KOBAYASHI, Miyoshi-shi (JP); Takayuki AOKI, Toyota-shi (JP); Ryusuke OHTA, Toyota-shi (JP); Tomohiro INADA, Kariya-shi (JP); Hitoshi MURAKI, Niwa-gun (JP)

(21) Appl. No.: 17/991,127

(22) Filed: Nov. 21, 2022

(30) Foreign Application Priority Data
Nov. 22, 2021 (JP) 2021-189197

(51) Int. Cl. G06T 7/73; G06F 3/14

(52) U.S. Cl. CPC G06T 7/73; G06F 3/14; G06T 2207/30204

(57) ABSTRACT

An image display apparatus includes: a display device to be worn on the head of a user who is a person on board a vehicle, and configured to display a target image in a superimposed manner in a field of view of the user; a SLAM-purpose camera fixed to the display device and configured to obtain a SLAM-purpose image capturing surroundings of the display device; a memory configured to store marker information indicating features of interior parts for the vehicle; and a device controller configured to detect, using the marker information, a marker from the SLAM-purpose image in which interior parts inside the vehicle are captured, and determine a display position of the target image based on the detected marker.

### CROSS REFERENCE TO RELATED APPLICATION

This application claims priority to Japanese Patent Application No. 2021-189197 filed on Nov. 22, 2021, which is incorporated herein by reference in its entirety including the specification, claims, drawings, and abstract.

### TECHNICAL FIELD

The present specification discloses an image display apparatus that displays a target image in a superimposed manner in the field of view of a user who is a person on board a vehicle.

### BACKGROUND

Conventionally, there are known techniques of displaying a predetermined image in a superimposed manner in the field of view of a user, to thereby cause the user to perceive that a virtual object represented by the image is present in reality. For example, Patent Literature 1 discloses a technique in which smart glasses, which are an eyeglass type display device, are worn by a driver, and an image representing a leading vehicle, that guides the vehicle the driver is in, is displayed on the smart glasses. In Patent Literature 1, the leading vehicle represented by the image moves so as to guide the vehicle the driver is in to a destination. Accordingly, the driver can travel to the destination by performing driving manipulations to follow the leading vehicle.

Patent Literature 2 discloses a contact lens type display device, instead of an eyeglass type display device.

### CITATION LIST

### Patent Literature

Patent Literature 1: JP 2017-129406 A
Patent Literature 2: WO 2014/178212 A

Here, in order to cause the user to perceive that a virtual object is present in reality, it is necessary to determine the display position of the image to be displayed on the display device (hereinafter referred to as the “target image”) based on the position in real space of the virtual object represented by the target image and the position in real space of the display device.

In Patent Literature 1, for the purpose of identifying the position of the display device in real space, a camera is mounted to the display device, and a marker is provided by, for example, mounting a dedicated marker for that purpose on the dashboard, or allowing the windshield to serve as the marker. An image of a scene including the marker is captured using the camera, and based on the captured image, the position of the display device in real space is identified.

However, a dedicated marker as noted above must be specially provided. Further, since a marker implemented by the windshield varies depending on the surrounding lighting environment conditions and the like, there may be difficulties in recognizing that marker, and its detection may require time or may incur a large processing load. Furthermore, when the position of the marker cannot be detected, the position of the display device in real space cannot be detected, resulting in that the display position of the target image cannot be determined.

In view of the above situation, the present specification discloses an image display apparatus that can determine the display position of the target image in a more appropriate manner.

### SUMMARY

An image display apparatus as disclosed in the present specification includes: a display device to be worn on the head of a user who is a person on board a vehicle; and configured to display a target image in a superimposed manner in a field of view of the user; a SLAM-purpose camera fixed to the display device and configured to obtain a SLAM-purpose image capturing surroundings of the display device; a memory configured to store marker information indicating features of interior parts for each vehicle; and a device controller configured to detect, using the marker information, a marker from the SLAM-purpose image in which interior parts inside the vehicle are captured, and determine a display position of the target image based on the detected marker.

The marker information may be downloaded from outside and stored in the memory.

The marker may be a shape provided in an instrument panel inside the vehicle, or a shape of a black ceramic part on a windshield.

According to the technique disclosed in the present specification, the display position of a target image can be determined in a more appropriate manner.

### BRIEF DESCRIPTION OF DRAWINGS

Embodiment(s) of the present disclosure will be described based on the following figures, wherein:

FIG. 1 is a block diagram showing a configuration of an image display apparatus;

FIG. 2 is a diagram showing a state in which a wearable device is worn by a user;

FIG. 3 is a diagram schematically illustrating a field of view of a driver who is the user;

FIG. 4 shows conceptual diagrams for explaining a space-fixed display mode and a device-fixed display mode;

FIG. 5 is a diagram schematically illustrating a field of view of a user when target images are displayed;

FIG. 6 is a flowchart showing an initial setting process performed by the image display apparatus 10 when a user boards the vehicle; and

FIG. 7 is a flowchart showing a process of displaying a target image during driving.

### DESCRIPTION OF EMBODIMENTS

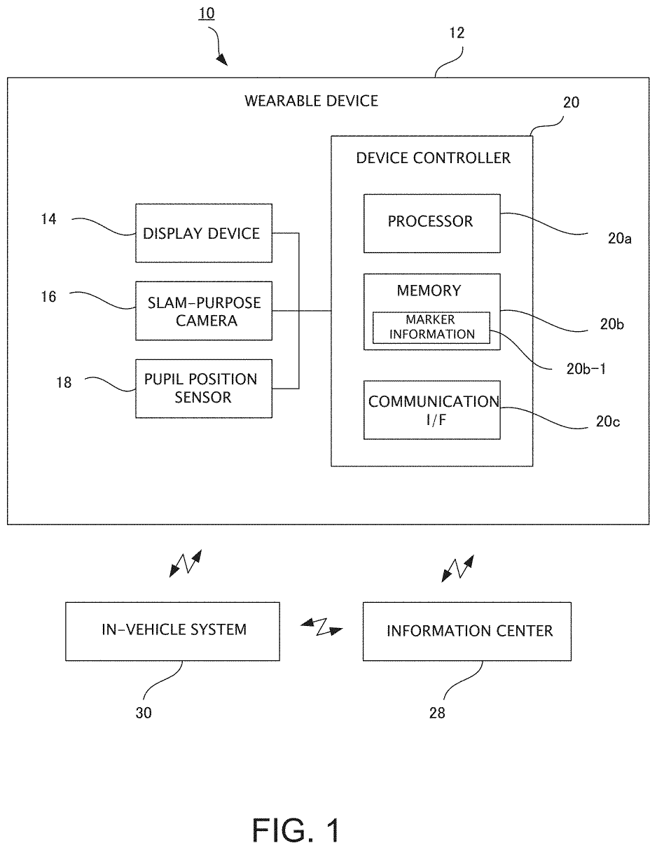

A configuration of an image display apparatus will now be described by reference to the drawings. Although the following description refers to specific aspects in order to facilitate understanding, those aspects are examples only and may be changed as appropriate. FIG. 1 is a block diagram showing a configuration of an image display apparatus 10. In the present embodiment, the image display apparatus 10 is implemented in a wearable device 12.

The wearable device 12 is a device to be worn on the head of a person (e.g., a driver) on board a vehicle, and is, for example, an eyeglass type or goggle type device. In order to function as the image display apparatus 10, the wearable device 12 comprises a display device 14, a SLAM-purpose camera 16, a pupil position sensor 18, and a device controller 20. As the wearable device 12, a contact lens type device may alternatively be used. In that case, the SLAM-purpose camera 16 and the device controller 20 are mounted to the contact lens. Since the contact lens basically moves following the movement of the pupil, the pupil position sensor 18 is not necessary. Although the device appearance differs greatly from an eyeglass type device, the contact lens type device is substantially identical thereto in function, and the configuration of an eyeglass type device can be employed for the contact lens type device without change.

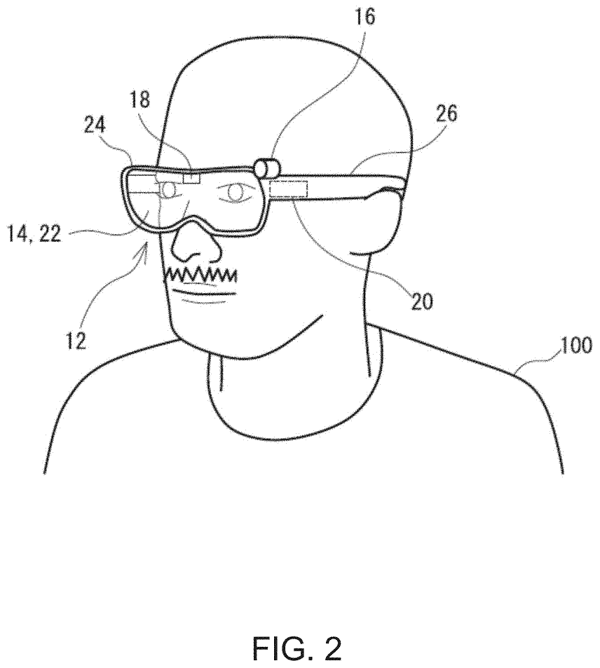

The wearable device 12 will be described by reference to FIG. 2. FIG. 2 is a diagram showing a state in which the wearable device 12 is worn by a user 100 who is a person on board a vehicle. The wearable device 12 is a device formed in the shape of eyeglasses, and is referred to as smart glasses or AR glasses. The wearable device 12 comprises temples 26 which are linear frame parts for resting on the ears, and a rim 24 which is a frame surrounding the environs of the eyes and formed in a shape capable of resting on the nose.

The display device 14 displays images in the field of view of the user 100 wearing the wearable device 12. In the present embodiment, the display device 14 is an organic EL display or liquid crystal display having a display area 22 located on the inside of the rim 24, and displays images in a part or the entirety of this display area 22. The display area 22 has high transparency. Accordingly, when no image is displayed in the display area 22, the user 100 (i.e., the person on board) can view the scene in front over the display area 22. Further, when an image is displayed only in a part of the display area 22, the user 100 can view the scene in front and the displayed image at the same time. At that time, the image may be opaque or semi-transparent. In the following description, an image displayed on the display device 14 will be referred to as a “target image” in order to distinguish from other images.

The SLAM-purpose camera 16 is a camera which is fixed to the display device 14 and which captures images of the surroundings of the display device 14. The SLAM-purpose camera 16 is, for example, fixed facing forward in the vicinity of a front end of a temple 26, and captures images of a region similar to the field of view of the user 100. In the following, an image captured using this SLAM-purpose camera 16 will be referred to as a “SLAM-purpose image”. As will be described further below, the device controller 20 identifies the position and orientation of the display device 14 in real space based on AR markers captured in a SLAM-purpose image.

The pupil position sensor 18 is a sensor that detects the position of the pupils of the right and left eyes of the user 100, and is, for example, fixed near the center of the rim 24. This pupil position sensor 18 may be formed using, for example, a camera and the like.

The device controller 20 controls the operation of the wearable device 12. The device controller 20 obtains images and position information obtained using the SLAM-purpose camera 16 and the pupil position sensor 18, processes such information, and causes the display device 14 to display a target image.

In physical terms, the device controller 20 is a computer comprising a processor 20a, a memory 20b, and a communication I/F 20c. The term “computer” as used herein covers a microcontroller incorporating a computer system in a single integrated circuit. Further, the processor 20a denotes a processor in a broad sense, and includes a general-purpose processor (e.g., a CPU (central processing unit), etc.), a dedicated processor (e.g., a GPU (graphics processing unit), an ASIC (application-specific integrated circuit), a FPGA (field-programmable gate array), a programmable logic device, etc.), and the like.

The memory 20b stores digital data necessary for the computer to perform processing. This memory 20h includes at least one of a main memory connected to the processor 20a via a memory bus, or a secondary storage device accessed by the processor 20a via an input/output channel. The memory 20b can be constituted of a semiconductor memory (e.g., a RAM, a ROM, a solid-state drive, etc.).

The communication I/F 20c is wirelessly connected to another electronic device, specifically an in-vehicle system 28, and can access various websites via the Internet. In particular, the communication I/F 20c can communicate with an information center 30 that provides vehicle information. Further, the communication I/F 20c may perform data transmission and reception with the in-vehicle system 28 via near-field communication such as CAN (controller area network) communication, Bluetooth (registered trademark), Wi-Fi (registered trademark), and infrared communication.

The above-described functions of the device controller 20 may alternatively be implemented by an external system such as a computer of the in-vehicle system 28, a computer of the information center 30, or a separate portable computer (e.g., a smartphone, etc.). In that case, the device controller 20 transmits the information from the SLAM-purpose camera 16 and the pupil position sensor 18 to the external system such as the in-vehicle system 28, receives back image data which are the results of processing, and displays the image data on the display device 14. It is also possible to execute a part of these processes in an external system.

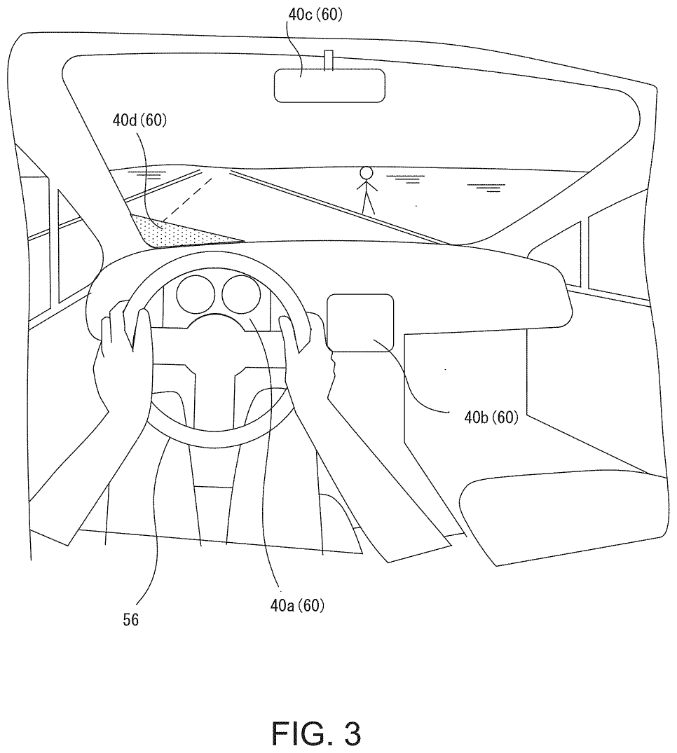

The in-vehicle system 28 is a system installed in the vehicle, and controls various in-vehicle devices. Here, as shown in FIG. 3, the in-vehicle system 28 includes, as interior parts, a meter display 40a provided in the instrument panel, a multi-function display 40b provided in the center console, and an electronic inner mirror 40c provided on the inner side of an upper part of the windshield. Shapes of these interior parts are relatively easily extracted. Accordingly, these shapes are used as AR markers 60, Further, at a lower corner portion of the windshield, a black ceramic part 40d is arranged. The pattern formed by this black ceramic part is easily recognized as a marker. Accordingly, this black ceramic part 40d is also used as an interior part that serves as a target of extraction as an AR marker 60.

FIG. 3 is a diagram schematically illustrating a field of view of a driver who is the user 100. The meter display 40a is a display that displays information related to the state of the vehicle, such as vehicle speed and fuel consumption. As shown in FIG. 3, this meter display 40a is located across the steering wheel 56 from the driver, and the driver can view the display area of the meter display 40a over the steering wheel 56.

The multi-function display 40b is a display that displays information related to in-vehicle electronic devices (such as a navigation device and an audio device). As shown in FIG. 3, this multi-function display 40h is located at the center of the instrument panel in the vehicle width direction, that is, at the position generally referred to as the center console.

The electronic inner mirror 40c is a display that displays images of the vehicle rear scene captured by a rear camera (not shown in drawing). This electronic inner mirror 40c is used in place of a rearview mirror that shows the vehicle rear scene by optical reflection. The electronic inner mirror 40c may be one that is switchable between a digital mode for displaying images and a mirror mode for showing the vehicle rear scene by optical reflection. As shown in FIG. 3, the electronic inner mirror 40c is arranged at a position equivalent to that of a typical rearview mirror, that is, at a position near the upper end part of the windshield glass. Instead of the electronic inner mirror, a typical rearview mirror may be used.

As noted above, the device controller 20 generates data of a target image to be displayed on the display device 14. Here, although it is possible to use a “device-fixed display mode” and a “space-fixed display mode” as the display modes for displaying a target image on the display device 14, in the present embodiment, the “space-fixed display mode” is used. This space-fixed display mode is a display mode in which a target image representing a predetermined object is displayed so as to appear to be present in real space.

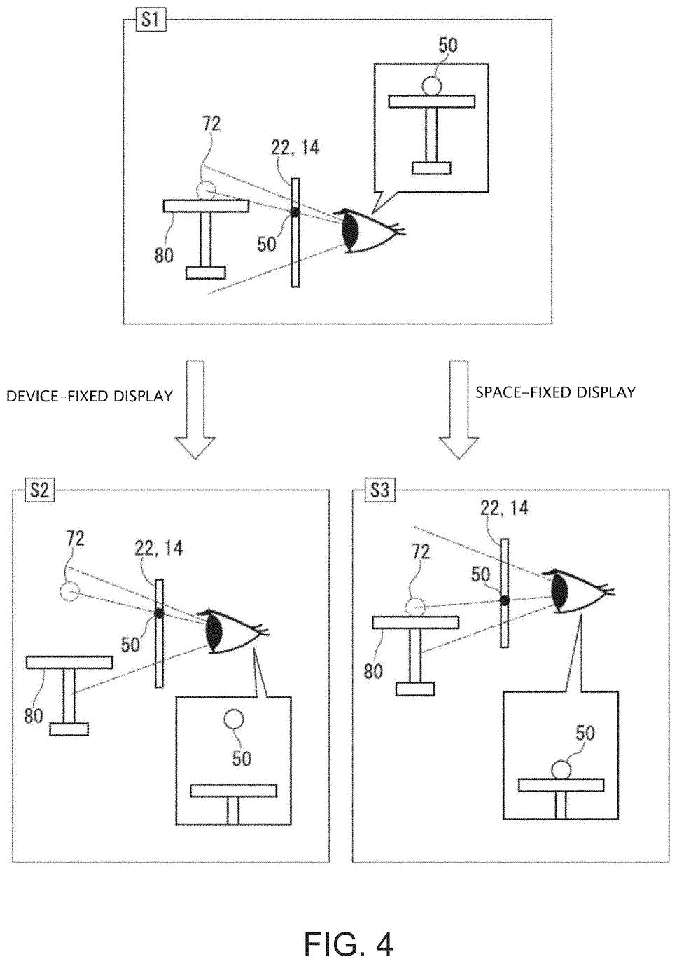

As an example, reference will be made to a situation as shown in FIG. 4 where the user 100 views, across the display area 22 of the display device 14, a real space in which a table 80 is actually present. In this situation, when a target image 50 representing a sphere is displayed in the display area 22 as shown in the state S1 of FIG. 4, as a natural result, the real space containing the table 80 and the target image 50 showing the sphere appear at the same time in the field of view of the user 100.

When in the device-fixed display mode, the display position of the target object 72 (in the example of FIG. 4, the sphere) represented by the target image 50 is determined independently of the real space. Therefore, in the device-fixed display mode, even when the viewpoint of the user 100 is moved, no change is made to the display position, size, or shape of the target image 50 in the display area 22, as shown in the state S2 of FIG. 4.

In contrast, in the space-fixed display mode, it is identified where the target object 72 (in the example of FIG. 4, the sphere) represented by the target image 50 is located in real space, and the target image 50 is displayed so as to appear to be actually present at the identified position. As an example, reference will be made to a case where, in the space-fixed display mode, it is assumed that the target object 72, i.e., the sphere, is located on the table 80 in the real space. In this case, changes are made to the display position, size, and shape of the sphere in the display area 22 so that, as shown in the state S3 of FIG. 4, the sphere appears to be located on the table 80 even when the viewpoint of the user 100 is moved.

By displaying the target image 50 as such in the space-fixed display mode, the user 100 perceives an illusion that the target object 72 shown by the target image 50 is present in reality. In other words, by displaying the target image 50 in the space-fixed display mode, information can be added, deleted, emphasized, and attenuated in a real environment, and the real world as viewed by a human can be augmented. Such a technology is generally referred to as “augmented reality” or “AR”.

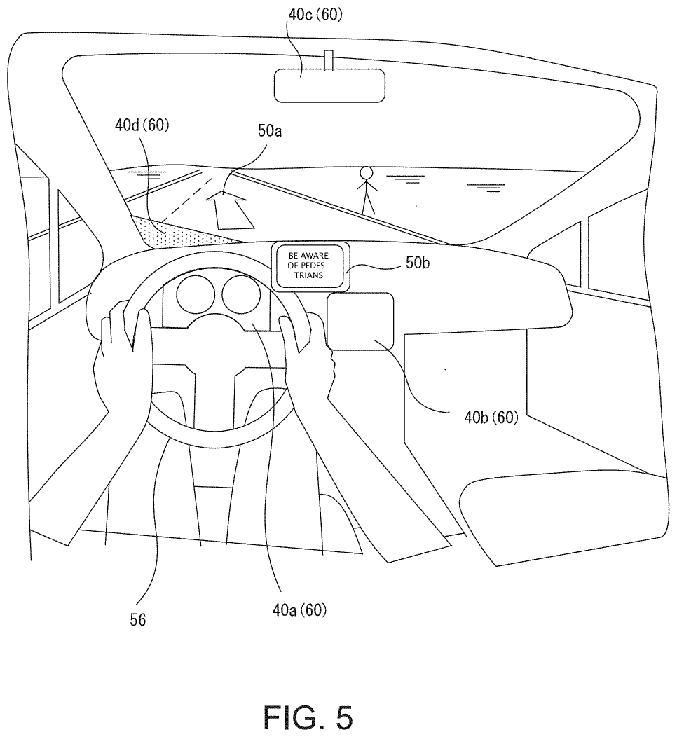

Next, an example display of target images 50 according to the present embodiment will be described. FIG. 5 is a diagram schematically illustrating a field of view of a user 100 (in the present embodiment, a driver) when target images 50a, 50b are displayed. In the example of FIG. 5, a target image 50a indicating the vehicle travel direction and a target image 50b showing a warning message to the driver are displayed in the space-fixed display mode. These target images 50a, Sob are displayed on the display device 14 so as to appear to be located at the same position and having the same size as when the target objects shown by these target images are present in reality. For example, the target image 50a is displayed in the display area 22 so as to appear to be located at the same position and having the same size as when an arrow-shaped object represented by the target image 50a is actually present on a road surface that is actually present in front of the vehicle. Further, the target image 50b is displayed in the display area 22 so as to appear to be located at the same position and having the same size as when a text object represented by the target image Sob is actually present at a position toward the upper right from the steering wheel 56 that is actually present. Accordingly, when the viewpoint of the user 100 is moved, the display position and size of these target images 50a, 50b in the display area 22 are changed.

As such, in the space-fixed display mode, since a target image 50 can be displayed in consideration of arrangements of actual objects, it is possible to reliably prevent the target image 50 from obstructing drive manipulations. Further, in the space-fixed display mode, a target image 50 can be displayed at a position having correlation with an actual object (such as a pedestrian), and it is thereby possible to effectively direct the attention of the user 100 to that object.

In order to perform display in the space-fixed display mode, it is necessary to accurately detect the position of the pupils relative to the display device 14, as well as the position and orientation of the display device 14 in real space. The device controller 20 determines the position and the like of a target image 50 within the display area 22 based on the position and orientation of the target object in real space, the position and orientation of the display device 14 in real space, and the position of the pupils relative to the display device 14. Among these, the position of the pupils relative to the display device 14 is detected using the pupil position sensor 18, as noted above.

The position and orientation of the display device 14 in real space are calculated by the device controller 20 by performing visual SLAM (simultaneous localization and mapping) based on a SLAM-purpose image obtained using the SLAM-purpose camera 16. Visual SLAM is a technology for simultaneously estimating, based on an image captured using a camera, three-dimensional environment information and the position and orientation of the camera. In order to perform visual SLAM, characteristic shapes of a plurality of interior parts inside the vehicle are recognized as AR markers 60 (see FIG. 3). The device controller 20 can extract a plurality of AR markers 60 from a SLAM-purpose image captured using the SLAM-purpose camera 16, and calculate the position and orientation of the display device 14 in real space based on information such as the positional relationship between these AR markers within the SLAM-purpose image. Further, it is also possible to calculate the position and orientation of the display device 14 in real space based on the coordinates, size, distortion, and the like of a single AR marker 60 within the SLAM-purpose image.

In the present embodiment, the memory 20b comprises a marker information storage unit 20b-1, and marker information regarding the position, size, and shape of interior parts that serve as AR markers 60 are stored therein in advance. For example, at the time of manufacture of the vehicle, the marker information regarding interior parts that are candidates for AR markers 60 for that vehicle may be stored in a memory in the in-vehicle system 28, and at the time of an initial setting process of the image display apparatus 10 (or the wearable device 12), the image display apparatus 10 may communicate with the in-vehicle system 28 to obtain data regarding the interior parts that serve as AR markers 60, and store the data in the marker information storage unit 20b-1 of the memory 20b. The image display apparatus 10 may also obtain vehicle type information, which may be received from the in-vehicle system 28, via input of the vehicle type information by the user, or via communication with the information center 30, and may acquire data regarding the interior parts that serve as AR markers 60 from the vehicle type information.

As such, the marker information storage unit 20b-1 has stored therein information regarding the interior parts that serve as candidates for AR markers 60. Based on the marker information stored in the marker information storage unit 20b-1, the image display apparatus 10 performs image recognition processing with respect to a SLAM-purpose image captured using the SLAM-purpose camera 16, and achieves image recognition of the AR markers 60 in the SLAM-purpose image. At that time, since the marker information is used, the AR markers 60 can be reliably extracted by relatively simply processing similar to that in a case where AR markers 60 having fixed shapes are employed.

After that, using the recognition results concerning the recognized one or plurality of AR markers 60, the display position, size, and shape of the target image 50 are determined, and the target image 50 is displayed on the display device 14.

It is possible to adopt an arrangement in which: information regarding a plurality of AR marker candidates is included as the marker information; for each AR marker candidate, a score obtained in performing its image recognition from a SLAM-purpose image (i.e., a score of similarity in recognition) is detected as appropriate; and a higher priority level is assigned to a candidate having a higher score. Then, in detecting AR markers 60 during travel, by performing recognition of only a small number of (e.g., two) AR markers having the highest priority levels, the processing load can be reduced.

Further, from the information center 30 or the like, the data regarding interior parts that serve as AR markers 60 can be obtained corresponding to the vehicle type. Accordingly, marker information corresponding to the vehicle being used can be registered in the memory 20b, and the AR markers 60 can be detected based on appropriate information regarding the AR markers 60.

### <Initial Setting Process>

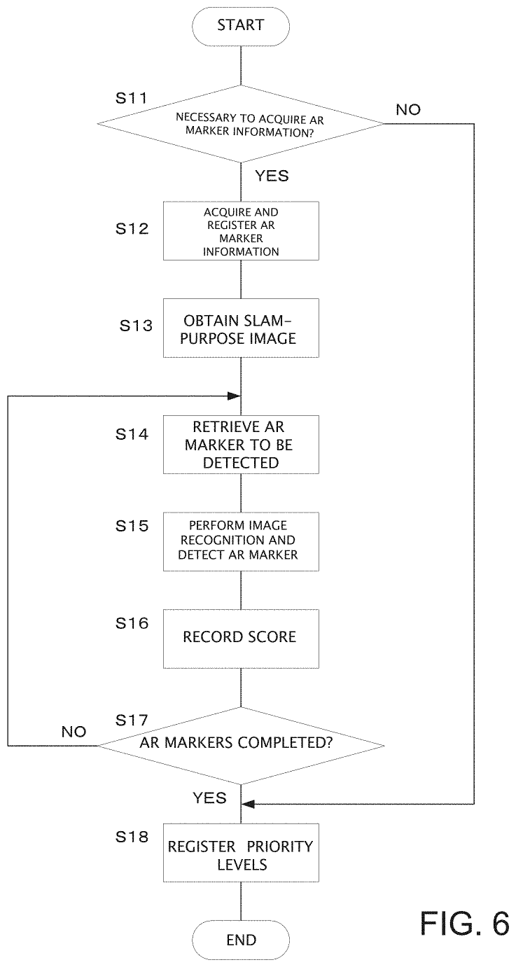

FIG. 6 is a flowchart showing an initial setting process performed by the image display apparatus 10 when a user boards the vehicle.

When the wearable device 12 is brought into the vehicle and the power is turned ON, a determination is made regarding whether to acquire marker information (S11). When a new wearable device 12 is brought into the vehicle, the image display device 10 may be automatically set to a marker information acquisition mode. The image display device 10 may communicate with the in-vehicle system 28 and thereby determines whether the wearable device 12 has been used in the past. The image display device 10 may periodically transmit an inquiry to the information center 30 so as to determine whether update information is available, and when the update information is available, YES may be determined in S11.

When the result of the determination in S11 is YES, marker information is acquired from the in-vehicle system 28 or the external information center 30, and the marker information is registered in the marker information storage unit 20b-1 (S12).

Next, a SLAM-purpose image is obtained (S13), and marker information regarding a single registered AR marker 60 is retrieved (S14). Using the retrieved marker information, the AR marker 60 is detected by performing image recognition (S15). Then, a score for the image recognition processing is recorded (S16) The score may be stored as one marker information item in the marker information storage unit 20b-1.

Subsequently, a determination is made regarding whether the processing is completed for all AR markers 60 stored in the marker information storage unit 20b-1 (S17), When the result of this determination is NO, the process returns to S14.

When the result of the determination in S17 is YES, priority levels are registered for all processed AR markers (S18). Here, even when the result of the determination in S11 is NO, S18 is performed to register priority levels. Information such as a score for image recognition processing obtained when a process of displaying a target image during driving is performed and the number of times an AR marker is used that are described later may be used for the priority registration of S18.

### <Display of Target Image>

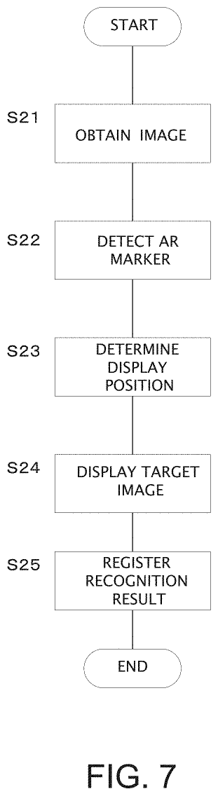

FIG. 7 is a flowchart showing a process of displaying a target image during driving.

First, an image from the SLAM-purpose camera 16 is retrieved (S21). Using the information of the registered AR markers, the AR markers 60 are detected form the image (S22). In performing this AR marker 60 detection, processing may be executed simultaneously regarding the plurality of AR markers stored in the marker information storage unit 20b-1 based on the marker information thereof, or the processing may be performed sequentially, for one AR marker at a time.

Next, using the position information of the recognized AR markers 60, a display position of a target image 50 is determined (S23), and the target image 50 is displayed at the determined position (S24). Then, a score of the AR marker recognition and the like obtained during the display processing performed at this time are recorded (S25).

Although an eyeglass type device was used as the wearable device 12 in the above-described embodiment, a contact lens type device can alternatively be used. Further, although a display that displays an image in the display area 22 was described as an example display device 14, the display device 14 may alternatively be a projector that projects an image on a retina of the user 100. Furthermore, in the above description, the user 100 views the real space over the transparent display area 22. However, the display area 22 may alternatively be configured opaque such that the user 100 cannot view the real space over the display area 22. In that case, the device controller 20 displays, in the display area 22, a synthesized image formed by synthesizing a captured image of the real space and a target image representing a virtual object.

1. An image display apparatus comprising:
a display device to be worn on the head of a user who is a person on board a vehicle, and configured to display a target image in a superimposed manner in a field of view of the user;
a SLAM-purpose camera fixed to the display device and configured to obtain a SLAM-purpose image capturing surroundings of the display device;
a memory configured to store marker information indicating features of interior parts for the vehicle, and
a device controller configured to detect, using the marker information, a marker from the SLAM-purpose image in which interior parts inside the vehicle are captured, and determine a display position of the target image based on the detected marker.

2. The image display apparatus according to claim 1, wherein
the marker information is downloaded from outside and stored in the memory.

3. The image display apparatus according to claim 1, wherein
the marker is a shape provided in an instrument panel inside the vehicle, or a shape of a black ceramic part on a windshield.

4. The image display apparatus according to claim 2, wherein
the marker is a shape provided in an instrument panel inside the vehicle, or a shape of a black ceramic part on a windshield.
